(19) United States
(12) Patent Application Publication
(10) Pub. No.: US 2009/0170563 A1
(43) Pub. Date: Jul. 2, 2009

(54) VOICE COMMUNICATION DEVICE

(75) Inventor: MENG-CHUN CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/141,220

(22) Filed: Jun. 18, 2008

(30) Foreign Application Priority Data
Dec. 27, 2007 (CN) 200710203455.3

(51) Int. Cl. H04M 1/00

(52) U.S. Cl. 455/566; 455/550.1

(57) ABSTRACT

A portable electronic device (100) such as a mobile phone includes a plurality of microphones arranged/configured at different locations and for receiving audio input from different directions. A signal processor (127) electronically connected with the microphones separate the audio input into a plurality of isolated voice signals and an audio detector (129) electronically connected with the signal processor selects the best quality voice signal from the plurality of isolated voice signals.

### BACKGROUND OF THE INVENTION

1. Field of the Invention

The present invention generally relates to portable electronic devices, particularly to a voice communication device with background noise suppressing function.

2. Discussion of the Related Art

With the development of wireless communication and information processing technologies, portable electronic devices, such as mobile phones and personal digital assistants (PDAs), are now in widespread use.

When a mobile phone is used in a noisy environment, background noise is usually transmitted with the voice signal to the receiving phone, degrading the quality of the call. As a result, the person on the other phone cannot hear the transmitted voice signal clearly.

Therefore, a portable electronic device, such as a mobile phone, with a background noise suppressing function is desired in order to overcome the above-described problems.

### BRIEF DESCRIPTION OF THE DRAWINGS

Many aspects of the voice communication device can be better understood with reference to the following drawings. Drawings are not necessarily drawn to scale, the emphasis instead being placed upon clearly illustrating the principles of the present voice communication device. Moreover, in the drawings, like reference numerals designate corresponding parts throughout the several views, in which:

FIG. 1 is an isometric view of a voice communication device according to an exemplary embodiment; and

FIG. 2 is a functional block diagram of the voice communication device shown in FIG. 1.

### DETAILED DESCRIPTION OF THE EMBODIMENTS

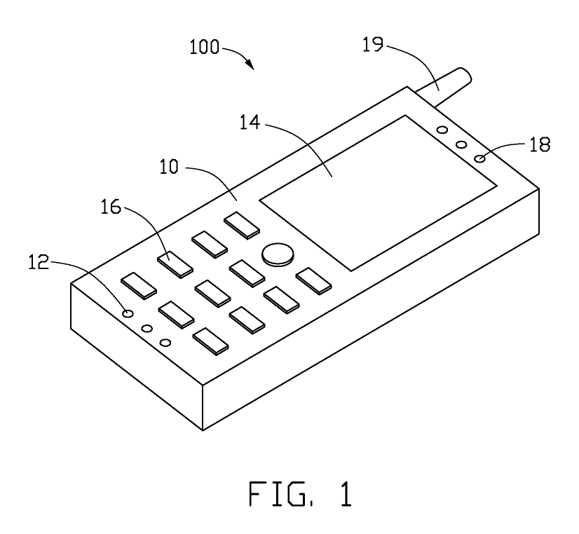

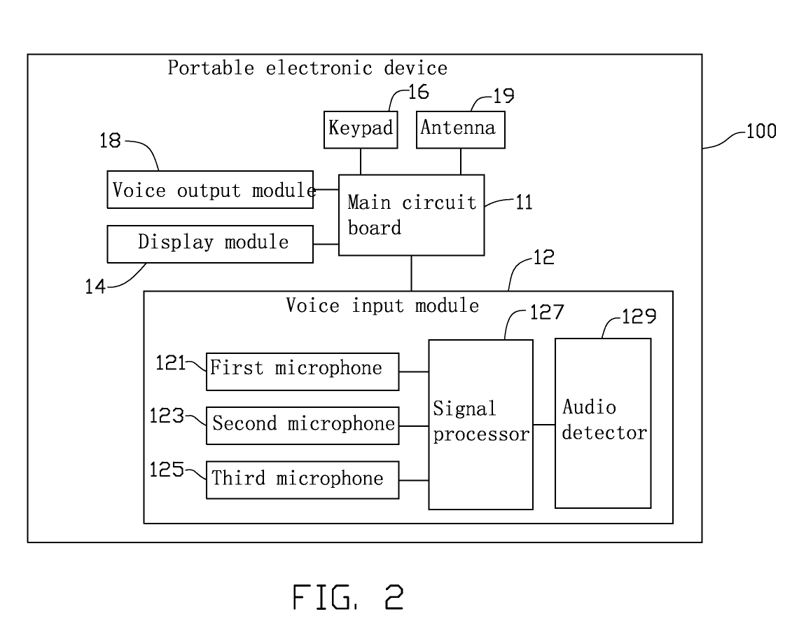

Referring to FIGS. 1 and 2, a voice communication device 100 is an exemplary mobile phone. The voice communication device 100 includes a main body 10 and a plurality of functional modules in the main body 10. The function modules include, for example, a main circuit board 11, a voice input module 12, a display module 14, a keypad 16, a voice output module 18 and an antenna 19. The voice input module 12, the display module 14, the keypad 16, the voice output module 18, and the antenna 19 are electronically connected to the main circuit board 11, so that data can be transmitted therebetween.

In use, audio input is received by the device 100 through the voice input module 12, processed, and then sent to a person on the other side of the communication though the antenna 19. The voice input module 12 includes a plurality of microphones, a signal processor 127, and an audio detector 129. In the exemplary embodiment, the microphones include a first microphone 121, a second microphone 123, and a third microphone 125. The microphones 121, 123, 125 are electronically connected to the audio detector 129 through the signal processor 127 and are positioned at different locations in the main body 10 for receiving audio input from different directions and for sending the received audio input to the signal processor 127. The signal processor 127 includes a conventional software-based voice signal analyzing process that analyzes and separates the audio input into a plurality of isolated voice signals. The audio detector 129 selects the best quality voice signal from the plurality of isolated voice signals.

The display module 14 includes a liquid crystal display (LCD) configured for displaying, among other things, content input to the keypad 16 and content received/sent by the device 100. The keypad 16 is configured for inputting information, commands etc. The voice output module 18 can be a transceiver, speaker, or other audio output means configured for outputting voice signals. In the exemplary embodiment the voice output module 18 is a transceiver. The user of the device 100 can be heard by and hear the voice of the person on the other end of the communication through the voice output module 18.

The audio inputs may be a mixture of sounds, such as voice and background noise picked up from different directions by microphones 121,123,125.

In use, the present voice communication device 100 receives the audio input, then through the voice signal analyzing process isolates voice from background noise. This creates one voice signal, and one or more background noise signals. In this embodiment three signals are given as an example, one voice signal and two background noise signals.

The three signals are sent to the audio detector 129 by the signal processor 127. The audio detector 129 distinguishes/identifies the voice signal. Then, the voice signal is sent to the receiving communication device on the other end of the communication through the antenna 19. As a result, the receiving communication device receives a clear intelligible signal of user initiated audio input.

It should be understood that, the voice input module 12 can include any plural number of microphones. The present device can also be a PDA, a walkie-talkie, a radio, an electronic megaphone or any other portable or fixed electronic device with microphone function.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a main body;
a voice input module associated with the main body and including:
a plurality of microphones at different locations of the main body for receiving audio input from different directions respectively;
a signal processor electronically connected with the microphones for receiving audio input from the microphones and separating the audio input into a plurality of isolated voice signals; and
an audio detector electronically connected with the signal processor for selecting the best quality voice signal from the plurality of isolated voice signals.

2. The portable electronic device as claimed in claim 1, wherein the signal processor includes a software-based voice signal analyzing process for analyzing and separating the audio input into a plurality of isolated voice signals.

3. The portable electronic device as claimed in claim 1, further comprising a main circuit board, a display module, a keypad, a voice output module and an antenna associated with the main body, wherein the display module, the keypad, the voice output module and the antenna are all electronically connected to the main circuit board, so that data can be transmitted therebetween.

4. The portable electronic device as claimed in claim 3, wherein the display module includes a liquid crystal display.

5. The portable electronic device as claimed in claim 3, wherein the voice output module includes a transceiver.

6. The portable electronic device as claimed in claim 3, wherein the voice output module includes a speaker.
